(19) United States
(12) Patent Application Publication
(10) Pub. No.: US 2026/0262005 A1
(43) Pub. Date: Sep. 3, 2026

(54) JOINT SENSING AND POSITIONING MEASUREMENT

(71) Applicant: Lenovo (United States) Inc., Morrisville, NC (US)

(72) Inventors: Amal Chandran, Bengaluru (IN); Seyedomid Taghizadeh Motlagh, Oberursel (DE); Robin Rajan Thomas, Bad Nauheim (DE); Sheeba Backia Mary Baskaran, Friedrichsdorf (DE); Kolli Kishor, Bangalore (IN)

(73) Assignee: Lenovo (United States) Inc., Morrisville, NC (US)

(21) Appl. No.: 19/067,779

(22) Filed: Feb. 28, 2025

(51) Int. Cl. H04W 64/00; H04L 5/00; H04W 12/06

(52) U.S. Cl. CPC H04W 64/00; H04L 5/0051; H04W 12/06

(57) ABSTRACT

Various aspects of the present disclosure relate to joint sensing and positioning measurement. A device for wireless communication, such as a user equipment (UE) or a network equipment (NE) may receive one or more reference signals that represent transmitted and/or received signal paths evaluated for integrated sensing and positioning detection by joint measurement of signal parameters of one or more of the transmitted or received signal paths. The device may receive a sensing configuration that indicates one or more computation exclusions of at least one of the signal parameters of the transmitted and/or received signal paths from evaluation of the joint measurement for the integrated sensing and positioning detection.

### TECHNICAL FIELD

The present disclosure relates to wireless communications, and more specifically to a measurement configuration for privacy and security.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A device, such as a UE or NE, for wireless communication is described. The device may be configured to, capable of, or operable to perform one or more operations as described herein. For example, the device may be configured to, capable of, or operable to receive one or more reference signals that represent at least one of transmitted or received signal paths evaluated for integrated sensing and positioning detection by joint measurement of signal parameters of one or more of the transmitted or received signal paths; and receive a sensing configuration that indicates one or more computation exclusions of at least one of the signal parameters of the transmitted or received signal paths from evaluation of the joint measurement for the integrated sensing and positioning detection.

A processor (e.g., a standalone processor chipset, or a component of a device (e.g., a UE or an NE)) for wireless communication is described. The processor may be configured to, capable of, or operable to perform one or more operations as described herein. For example, the processor may be configured to, capable of, or operable to receive one or more reference signals that represent at least one of transmitted or received signal paths evaluated for integrated sensing and positioning detection by joint measurement of signal parameters of one or more of the transmitted or received signal paths; and receive a sensing configuration that indicates one or more computation exclusions of at least one of the signal parameters of the transmitted or received signal paths from evaluation of the joint measurement for the integrated sensing and positioning detection.

A method performed or performable by a device (e.g., a UE or an NE) for wireless communication is described. The method may include receiving one or more reference signals that represent at least one of transmitted or received signal paths evaluated for integrated sensing and positioning detection by joint measurement of signal parameters of one or more of the transmitted or received signal paths; and receiving a sensing configuration that indicates one or more computation exclusions of at least one of the signal parameters of the transmitted or received signal paths from evaluation of the joint measurement for the integrated sensing and positioning detection.

In some implementations of the device, the processor, and the method described herein, the device is a UE or an NE. In some implementations of the device, the processor, and the method described herein, the device, the processor, and the method may be configured to, capable of, or operable to at least one of preclude transmission of a reference signal (RS), restrict a direction of the transmission of the RS, or modify a power of the transmission of the RS based on the sensing configuration. In some implementations of the device, the processor, and the method described herein, the device is a receiving device, and the at least one processor is operable to cause the receiving device to preclude at least one of receiving a RS or processing the RS based on the sensing configuration. In some implementations of the device, the processor, and the method described herein, the device, the processor, and the method may be configured to, capable of, or operable to preclude sensing data as the at least one signal parameter of a RS based on the sensing configuration.

In some implementations of the device, the processor, and the method described herein, the device is operable as unified data management (UDM) and unified data repository (UDR), and the device, the processor, and the method may be configured to, capable of, or operable to maintain the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution.

In some implementations of the device, the processor, and the method described herein, the device is operable as a sensing and location management function (SLMF), and the device, the processor, and the method may be configured to, capable of, or operable to at least one of receive a request for a sensing operation, apply restrictions on the sensing operation, or modify the restrictions on the sensing operation; authenticate at least one of the request for the sensing operation or the restrictions on the sensing operation; and transmit, to one or more of a UE or an NE, a (re)configuration message to (re)configure at least one of the one or more computation exclusions or the restrictions on the sensing operation.

In some implementations of the device, the processor, and the method described herein, the device, the processor, and the method may be configured to, capable of, or operable to monitor restrictions on a sensing operation in one or more of an identified fixed geographic area or within a perimeter around a fixed geographic location based on the sensing configuration. In some implementations of the device, the processor, and the method described herein, the device, the processor, and the method may be configured to, capable of, or operable to at least one of apply restrictions on a sensing operation to a first set of devices, or exclude a second set of devices from the restrictions on the sensing operation. In some implementations of the device, the processor, and the method described herein, the device, the processor, and the method may be configured to, capable of, or operable to override restrictions on a sensing operation based on emergency, statutory, or geographic authority exclusions to at least one of add, modify, or remove one or more of the restrictions based on authentication to override the restrictions on the sensing operation.

An NE (e.g., a base station (BS)) for wireless communication is described. The NE may be configured to, capable of, or operable to perform one or more operations as described herein. For example, the NE may be configured to, capable of, or operable to receive a request for a sensing operation for integrated sensing and positioning detection by joint measurement of signal parameters of one or more transmitted or received signal paths; authenticate the request for the sensing operation; apply one or more computation exclusions of at least one of the signal parameters of the transmitted or received signal paths from evaluation of the joint measurement for the integrated sensing and positioning detection; and transmit, to one or more of a UE or additional NE, a sensing configuration message for the integrated sensing and positioning detection.

A processor (e.g., a standalone processor chipset, or a component of an NE) for wireless communication is described. The processor may be configured to, capable of, or operable to perform one or more operations as described herein. For example, the processor may be configured to, capable of, or operable to receive a request for a sensing operation for integrated sensing and positioning detection by joint measurement of signal parameters of one or more transmitted or received signal paths; authenticate the request for the sensing operation; apply one or more computation exclusions of at least one of the signal parameters of the transmitted or received signal paths from evaluation of the joint measurement for the integrated sensing and positioning detection; and transmit, to one or more of a UE or additional NE, a sensing configuration message for the integrated sensing and positioning detection.

A method performed or performable by an NE (e.g., a BS) for wireless communication is described. The method may include receiving a request for a sensing operation for integrated sensing and positioning detection by joint measurement of signal parameters of one or more transmitted or received signal paths; authenticating the request for the sensing operation; applying one or more computation exclusions of at least one of the signal parameters of the transmitted or received signal paths from evaluation of the joint measurement for the integrated sensing and positioning detection; and transmitting, to one or more of a UE or additional NE, a sensing configuration message for the integrated sensing and positioning detection.

### BRIEF DESCRIPTION OF THE DRAWINGS

FIG. 1 illustrates an example of a wireless communications system in accordance with aspects of the present disclosure.

FIG. 2 illustrates an example of a network entity operational as a sensing Tx node for sensing, in accordance with aspects of the present disclosure.

FIG. 3 illustrates an example of a UE operational as a sensing Tx node for sensing, in accordance with aspects of the present disclosure.

FIG. 4 illustrates an example of an integrated sensing and positioning framework, in accordance with aspects of the present disclosure.

FIG. 5 illustrates an example of a sensed object, with a sensing restrictions perimeter and transmit/receive (Tx/Rx) nodes, in accordance with aspects of the present disclosure.

FIG. 6 illustrates an example procedure for a sensing restrictions configuration (SRC)-enabled sensing function to configure SLMF security, in accordance with aspects of the present disclosure.

FIG. 7 illustrates an example procedure for an SRC-enabled sensing function to capture and filter sensing data, in accordance with aspects of the present disclosure.

FIG. 8 illustrates an example of a secure sensing function, in accordance with aspects of the present disclosure.

FIG. 9 illustrates an example of a sensing perimeter definition for a registered UE, in accordance with aspects of the present disclosure.

FIG. 10 illustrates an example procedure for sensing a registration request from a registered UE, in accordance with aspects of the present disclosure.

FIG. 11 illustrates an example procedure for sensing data delivery to a registered UE, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a UE or an NE in accordance with aspects of the present disclosure.

FIG. 16 illustrates a flowchart of a method performed by an NE in accordance with aspects of the present disclosure.

### DETAILED DESCRIPTION

In a wireless communications system, a UE and an NE (e.g., a BS, gNB, network entity, or network node) may support wireless communication, including reception and/or transmission of wireless communication, using time-frequency resources. For example, the UE and the NE may support communicating signals (e.g., carrying control information, data, and/or the like). It should be understood that various terms may be used interchangeably with “communicating,” such as “signaling,” “transmitting,” “receiving,” “outputting,” “forwarding,” “relaying,” “retrieving,” “obtaining,” and so forth.

Radio sensing may be implemented in a wireless communications system (e.g., a cellular wireless network), such as to improve network performance, as well as to provide for object detection and positioning. In particular, radio sensing can be used to obtain environment information from the transmission of a sensing RS from an NE or UE entity, from the reception of signal path reflections or echoes of a transmitted sensing excitation signal (e.g., reflected from the environment), and from processing the received reflections and inferring positioning and other object information from the environment.

With these techniques of viewing a UE as a target device and/or as a physical object, the sensing measurements of the UE (e.g., the physical device), as well as the positioning measurement of the UE, can be used for active sensing scenarios, where the UE may be embedded in a desired object to be sensed. Further, this enables integrated positioning and sensing, where the sensing and positioning information of a target UE device can be obtained and/or determined as a joint measurement configuration). The positioning information of the UE device (as a physical object) can enable an ability to augment and enhance the sensing measurements within an area of interest (e.g., a geographic location) for sensing, and the obtained sensing information and/or measurements of the UE can be utilized to augment and enhance the positioning measurements of the target UE.

However, in these conventional use cases, all of the various UEs and objects that are identified using the sensing techniques are considered as coequal or comparable to each other with no distinction between the various UEs and/or devices. This may be present a challenge in several situations, such as when security is an important aspect of the sensing and positioning. For example, law enforcement may require a specific fixed perimeter to be filtered or restricted from sensing, which could be around security personnel and/or around or at a location that is secured by law enforcement following an incident. Similar conditions may apply for an individual who prefers not to share sensing and/or positioning data, and privacy of the individual may be a user expectation within a perimeter around the individual. In some cases, some (or part) of the sensing data from a perimeter restricted from the sensing operation could be used for a dangerous situation alert and should be communicated irrespective of the privacy or security setting.

In view of these scenarios and other considerations described in the present disclosure, several conventional problems are addressed. A solution provides that radio configurations (including RS transmission, measurements, and computation of desired information) of a radio sensing operation and a target UE positioning operation can be jointly configured within the context of a radio access network (RAN). Further, a radio configuration of joint radio sensing and positioning measurements can be implemented such that the privacy and security context information can be associated with the sensing information, and permitting a controlled delivery of the sensing information to prospective location services (LCS) or sensing service (SS) clients. Other considerations include an area or perimeter around an object or a user, as well as the type of a geographical area. Other considerations may also include a type of sensing clients, such as an individual UE, an application function (AF), a service provider, a regulatory entity, public safety, commercial sensing, a network function (NF), such as a network induced sensing request, and/or a base station (BS).

Aspects of the disclosure include an integrated sensing operation by which a UE, an authorized sensing and location services (SLCS) client, or a statutory entity can request one or more restrictions (or a set of restrictions) around a specific perimeter, such as around a registered UE, around a global positioning system (GPS) location, or around a geometric location defined at least in part by a set of GPS location or an equivalent identifier to identify a geographic area. Additional aspects of the disclosure include techniques by which a SLMF can authorize incoming SLMF requests, as well as authenticate network entities requesting the SLMF data, and map the requests to identify the level of sensing requested. The incoming requests can be requested within the constraints of the restrictions that are configured by various network entities and stored along with subscription information in the UDM/UDR. The SLMF can configure (or reconfigure) a set of nodes for Rx/Tx and define the set of parameters, scheduling, and duration of capturing the sensing data adhering to the configured restrictions.

Additional aspects of the disclosure include techniques for using the subscription information either from a registered UE, from a registered LCS client, or for an identified DID document or smart contract within the decentralized identifier (DID) document. The perimeter and parameters around the sensing data can be filtered and delivered to the requesting client while ensuring that the security, privacy, and statutory provisions are satisfied. Aspects of the disclosure also include techniques by which a registered UE can subscribe to specific sensing data around the device within a specific perimeter allowed and restricted by the subscription.

Aspects of the present disclosure are described in the context of a wireless communications system. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

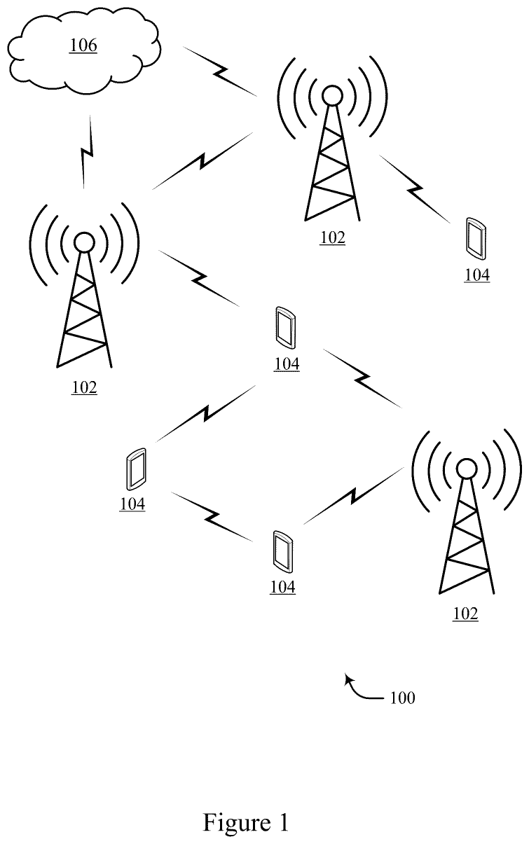

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may support joint sensing and positioning measurement. For example, an NE 102 and a UE 104 in the wireless communications system 100 may support an anchor node (RS Tx) that is configured by the network to transmit an RS, and a UE 104 measures the positioning-related measurements. A second anchor node (RS Rx) is configured by the network to perform radio sensing measurements, such as based on a known potential area of the UE 104 and/or the information known about the UE device (e.g., UE device radar cross section (RCS), and/or the UE immediate surrounding). The obtained radio sensing measurement from the RS Rx node, as well as the positioning measurements at the UE are collected and jointly processed at one or multiple network entities to estimate the UE position or orientation, heading, velocity, or a combination thereof.

With reference to obtaining a physical description of a target UE 104 from an application or RAN, and considering the target UE as a physical object, the sensing and positioning measurements can benefit from the previously known physical characteristics of the UE. To accomplish this, the requesting entity for sensing and/or positioning information indicates the physical characteristics of the target UE and/or RCS related information of the target UE to the sensing and positioning management entity. The sensing and positioning management entity utilizes this information for configuration of the sensing measurements, and for computation of the positioning information of the target UE.

With reference to the location and management function (LMF) obtaining sensing information and/or measurements, based on reception of a positioning information request of a target UE from an LCS client by the LMF, the LMF sends a request to a sensing function (SF) as the core network entity responsible (at least partially) for receiving sensing information, obtaining the sensing information, and exposing the obtained sensing information to the requesting node or entity for the desired sensing information of the target UE (e.g., device and/or object). The SF then obtains the requested sensing information and/or measurements of the UE and informs the LMF of the obtained information and/or measurements.

With reference to a core network (CN)-CN interface, the SF obtaining presence and/or location information of the UE devices and/or objects, based on reception of a request for sensing information at an area of interest for sensing by the SF (from a sensing client), the SF requests the LMF for the presence information of the UE devices at the indicated area of interest. The LMF may determine the presence of the UEs based on the prior UE position information or request NG-RAN nodes for determining the UE presence and/or position information at a given area of interest. The obtained UE information (e.g., a list of the present UE identifiers (IDs), UE position and/or velocity information, the UE RCS information, or a combination thereof) is then delivered to the SF.

According to implementations, one or more of the NEs 102 and the UEs 104 are operable to implement various aspects of the techniques described with reference to the present disclosure. For example, a device for wireless communication, such as a UE 104 or an NE 102, receives one or more reference signals that represent transmitted and/or received signal paths that can be evaluated for integrated sensing and positioning detection by joint measurement of signal parameters of one or more of the transmitted and/or received signal paths. The device, such as the UE 104 or the NE 102, receives a sensing configuration that indicates one or more computation exclusions of at least one of the signal parameters of the transmitted and/or received signal paths from evaluation of the joint measurement for the integrated sensing and positioning detection.

Radio sensing may be implemented in a wireless communications system (e.g., a cellular wireless network), both to improve network performance, as well as to provide for vertical use-cases. In particular, radio sensing can be used to obtain environment information by techniques that include (i) transmission of a sensing signal (e.g., a sensing RS from a network or UE entity, referred to herein as a sensing Tx node); (ii) reception of the reflections or echoes of a transmitted sensing excitation signal from the environment by a network or UE entity, referred to herein as a sensing Rx node; and (iii) processing of the received reflections and inferring relevant information from the environment.

With these techniques of viewing a UE (and/or the target UE device surroundings and/or attachments) as a physical object, the sensing measurements of the UE physical device, as well as the positioning measurement of the UE, can be jointly and/or interchangeably reused and/or optimized. This may also be referred to as active sensing scenarios, where the UE may be embedded in a desired object (or associated attachments) to be sensed. Moreover, this enables an integrated positioning and sensing framework, where (i) the sensing and positioning information of a target UE device can be jointly obtained and/or optimized (e.g., via a joint measurement configuration); (ii) the obtained positioning information of the UE device (as a physical object) would enable an ability to augment and enhance the sensing measurements within an area of interest for sensing; and (iii) the obtained sensing information/measurements of the UE physical object can be utilized to augment and enhance the positioning measurements of the target UE device.

In these cases, all UEs and objects identified using the sensing are considered coequal or comparable to each other with no distinction between each other. This is a challenge in several situations where security is important. Law enforcement may require a specific fixed perimeter to be filtered or restricted from sensing, which could be around security personnel and/or a location that is secured by the law enforcement following an incident. Similar conditions may apply for an individual, who prefers not to share the sensing data. The privacy of the individual, and a perimeter around the individual, should be respected with regards to the properties, pets, and other identifiable personal objects. In some cases, some (or part) of the sensing data from a perimeter restricted from the sensing operation could be used for a dangerous situation alert and should be communicated irrespective of the privacy or security setting.

In view of these scenarios and other considerations described in the present disclosure, several conventional problems are addressed. A solution provides that radio configurations (including RS transmission, measurements, and computation of desired information) of a radio sensing operation and a target UE positioning operation can be jointly configured within the context of a radio access network (RAN) A radio configuration of joint radio sensing and positioning measurements, such that the privacy and security context information can be tied to the sensing information and permission controlled delivery of the sensing information to prospective LCS or SS clients. Other considerations include an area or perimeter, an object or the user, a type of objects (e.g., human, pet, unmanned ariel vehicle (UAV), automobile), a type of geographical area (e.g., home, research-facility, or the like), and object characteristics (e.g., materials and compositions (metal fand wood), etc.). Other considerations may also include a type of sensing clients, such as an individual UE, an AF, a service provider, a regulatory entity, public safety, commercial sensing, a NF, such as a network induced sensing request, and/or a BS for communication to identify a blockage or improvement of communication channels. Other considerations may also include inter-operator functions, roaming, and an intra-home-area.

With reference to radio sensing scenarios, network-based and UE-based (SL-based) radio sensing operations are considered, and solutions proposed to cover scenarios of radio sensing, such as when the network configures the participating sensing entities (i.e., network and UE nodes acting as sensing Tx nodes, network and UE nodes acting as sensing Rx nodes, as well as the configuration of sensing RS and necessary measurements and reporting procedures from the nodes). In this regard, the functional split between the network and the UE nodes for a specific sensing task may take various forms, depending on the availability of sensing-capable devices and the requirements of the specific sensing operation. In some aspects, each triangulated object can be marked with an identification.

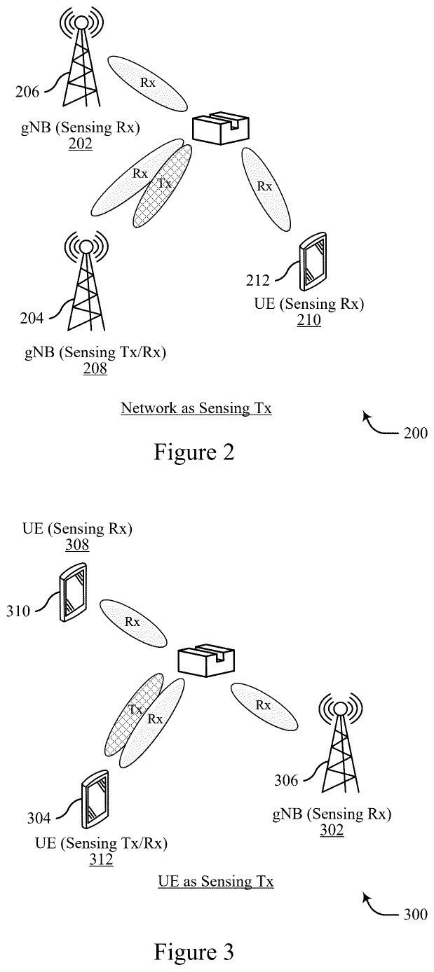

FIG. 2 illustrates an example 200 of a network entity operational as a sensing Tx node for sensing scenarios as related to specular reflection detection and measurement, in accordance with aspects of the present disclosure. As shown in the example 200, a first scenario 202 includes sensing Tx at a network node 204 (e.g., a gNB) and sensing Rx at a separate network node 206 (e.g., a gNB). In this example, the sensing RS (or another RS used for sensing or the data/control channels known to the network transmit-receive point (TRP) nodes) is transmitted and received by the network entities. The involvement of UE nodes is limited to the aspects of interference management, when necessary, and the network does not utilize the UEs for sensing assistance in this scenario.

A second scenario 208 includes sensing Tx at the network node 204 (e.g., a gNB) and sensing Rx at the same network node 204. In this example, the sensing RS (or another RS used for sensing or the data/control channels known to the network TRP nodes) is transmitted and received by the same network entity. The involvement of the UE nodes is limited to the aspects of interference management, when necessary, and the network does not utilize the UEs for sensing assistance in this scenario. A third scenario 210 includes sensing Tx at a network node 204 (e.g., a gNB) and sensing Rx at a UE node 212. In this example, the sensing RS or other RS used for sensing is transmitted by a network entity and received by one or multiple UE nodes (e.g., UE 212). The network configures the UEs to act as a sensing Rx node, according to the UE nodes capabilities for sensing, as well as a desired sensing task.

FIG. 3 illustrates an example 300 of a UE operational as a sensing Tx node for sensing scenarios as related to specular reflection detection and measurement, in accordance with aspects of the present disclosure. As shown in the example 300, a fourth scenario 302 includes sensing Tx at a UE 304 and sensing Rx as a network node 306 (e.g., a gNB). In this example, the sensing RS or other RS used for sensing (or a data/control channel transmitted by the UE 304) is received by one or multiple network entities and transmitted by a UE node. The network configures the UE 304 to operate as a sensing Tx node, according to the UE nodes capabilities for sensing, as well as the nature of the desired sensing task.

A fifth scenario 308 includes sensing Tx at the UE node 304 and sensing Rx at a separate UE node 310. In this example, the sensing RS or other RS used for sensing is received by one or multiple UE nodes and transmitted by a UE node. In this case, the network, or a UE node, can be implemented to determine a configuration of the sensing scenario. In one instance, the network configures the UEs to act as sensing Tx and/or sensing Rx nodes, according to the UE nodes capabilities for sensing, as well as the nature of the desired sensing task. A sixth scenario 312 includes sensing Tx at the UE node 304 and sensing Rx at the same UE node 304. In this example, the sensing RS (or another RS used for sensing or the data and/or control channels known to the UE) is transmitted by the UE node and received by the same UE node. In this case, the UE or the network configures the sensing scenario, according to the UE nodes capabilities for sensing, as well as the nature of the desired sensing task.

The above-described scenarios in examples 200 and 300 are not intended to be restricted to a specific UE type, and may include any UE category and/or functionality (e.g., a UE, a road-side unit (RSU)). In any of the above scenarios, any of the roles depicted for a gNB and/or a UE may be replaced (with equal validity as an example of a radio sensing scenario) with a smart repeater node, an IAB node, or an RSU.

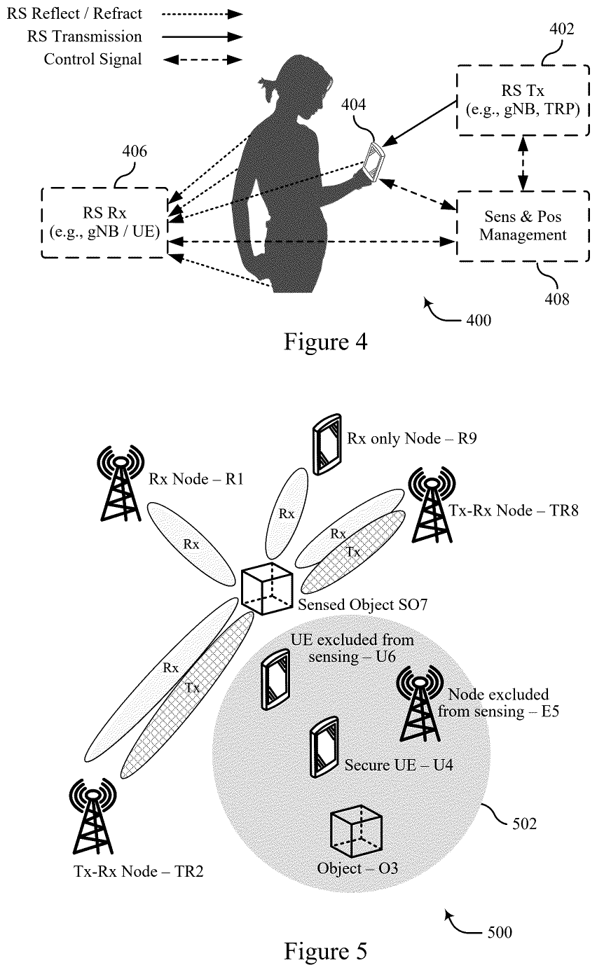

FIG. 4 illustrates an example 400 of an integrated sensing and positioning framework, in accordance with aspects of the present disclosure. In aspects of this disclosure, and with reference to RAN radio configuration of a joint radio sensing and positioning, a first anchor node 402 (RS Tx) is configured by the network to transmit a RS, and a UE 404 is configured to measure the positioning-related measurements (e.g., time-of-arrival (ToA), time-of-flight (ToF), angle-of-arrival (AoA), reference signal time difference (RSTD), Rx-Tx time difference, relative time-of-arrival (RTOA), reference signal received power (RSRP), and reference signal received path power (RSRPP) of one or multiple paths based on the RS reception). A second anchor node 406 (RS Rx) is configured by the network to perform radio sensing measurements (e.g., detection of an object in a pre-defined area, ToA/ToF from the paths within an area of interest for sensing, RSRPP and/or AoAs from the area of interest for sensing, measured time differences amongst different pairs of entities), based on a known potential area of the UE and/or information known about the UE 404 (e.g., UE device RCS, and/or the UE immediate surrounding). The obtained radio sensing measurement from the RS Rx anchor node 406, as well as the positioning measurements at the UE 404 are collected and jointly processed at one or multiple network entities (e.g., a sensing and positioning management entity 408) to estimate the UE position or orientation, heading, velocity, or a combination thereof.

With reference to obtaining a physical description of the UE 404 (e.g., a target UE) from an application or RAN, considering the UE as a physical object, the sensing and positioning measurements can benefit from the previously known physical characteristics of the UE. To accomplish this, the requesting entity for sensing and/or positioning information indicates the physical characteristics of the target UE and/or RCS related information of the target UE to the sensing and positioning management entity (autonomously or upon request of the sensing or positioning management entity). The sensing and positioning management entity utilizes this information for configuration of the sensing measurements, and for computation of the positioning information of the target UE.

With reference to a location and management function (LMF) obtaining sensing information and/or measurements, based on reception of a positioning information request of a target UE from an LCS client by the LMF, the LMF sends a request to an SF as the core network entity responsible (at least partially) for receiving sensing information, obtaining the sensing information, and exposing the obtained sensing information to the requesting node or entity for the desired sensing information of the target UE (e.g., device and/or object). The SF then obtains the requested sensing information and/or measurements of the UE and informs the LMF of the obtained information and/or measurements.

With reference to a core network (CN)-CN interface, the SF obtaining presence and/or location information of the UE devices and/or objects, based on reception of a request for sensing information at an area of interest for sensing by the SF (from a sensing client), the SF requests the LMF for the presence information of the UE devices at the indicated area of interest. The LMF may determine the presence of the UEs based on the prior UE position information or request NG-RAN nodes for determining the UE presence and/or position information at a given area of interest. The obtained UE information (e.g., a list of the present UE IDs, UE position and/or velocity information, the UE RCS information, or a combination thereof) is then delivered to the SF.

FIG. 5 illustrates an example 500 of a sensed object, with a sensing restrictions perimeter and Tx/Rx nodes, in accordance with aspects of the present disclosure. With reference to sensing restrictions configuration (e.g., as related to a perimeter and/or geographical area), a restricted perimeter (of a geographic area) for security and/or privacy may be set for filtering the sensing and positioning procedure. When the sensing restrictions perimeter 502 is configured, the sensing data captured from the defined perimeter around the configured area is identified by the sensing nodes, and the data is marked with specific security level information as configured. The geographic area, or the perimeter for sensing restrictions could be defined in multiple ways, such as a defined radius around specified geographic positioning coordinates, or defined by a set of coordinates that form a polygonal area that can identify the area, or defined by a tracking area code (TAC) that is defined by the network and identifies the location. In the case of sensing, this translates to the geographical coverage area of the cells that belong to the tracking area (TA) or a coverage area of a cell or multiple cells identified by the network for defining the perimeter. The perimeter may also be a dynamic perimeter, where the radius around a mobile UE is defined for sensing restrictions. In the case of a mobile object or dynamic geographic area being defined, the sensing restrictions apply for the perimeter that is identified as “restricted” at the time of the active sensing operation.

The SLMF and the UDM and/or UDR in coordination with each other (and other core network entities) can implement further restrictions, such as filtering the list of nodes allowed to transmit the sensing RS in the geo-location or geographical area or region requested for sensing, and/or filtering a list of nodes allowed to receive sensing RS in the geo-location or geographical area or region requested for a sensing function. Further restrictions may include defining a duration of time, an allowed sensing period, or a validity period for which the restrictions apply based, at least in part on, the subscription data, as authorized by the object or UE being the sensing target, the authorization level of the requesting client, or a DID document presented on the incoming request or a trusted third party or a statutory entity delivering the information or combination of configuration settings controlling the sensing function. Filtering the information in the reports generated from this sensing data using the security level information either from the incoming request, based on the subscription and authorization data from the originating entity of the request, or information stored in the UDM/UDR registry regarding the security and privacy configuration corresponding to the geo-location for which the sensing is requested.

With reference to security level configuration, different levels of security can be defined as the security level, and can be a number encoded to represent different levels of security and/or restrictions. One possible example is to use level 0 for indicating no restrictions and level 10 for maximum security and/or restrictions, which can translate to a highest level of restrictions. The security level information can be tied to the subscription of the UE, the sensing client, the application, or to the request for the sensing data. In an example, if the sensing restrictions configuration indicates a level of security L_{SCR} and the incoming request for sensing has identified the security level as L_{REQ} from a client with security level L_{CL}, then one of:
If L_{SCR}>L_{REQ}, then the restrictions defined with the security level L_{SCR} should apply to the request. Logically, this indicates that a restrictions configuration that is defined with a higher security level than the incoming request should be applied and filtered before the response is delivered to the request.
If L_{SCR}<=L_{REQ}, then the restrictions should be overridden. Any sensing restriction configuration that is defined with a security level below that of the incoming request, could be ignored or overridden by the sensing process.
If L_{CL}<=L_{REQ}, then the incoming request should be rejected. No client shall be allowed to make a sensing request that is above the security level of its own subscription.

As an example, a security entity or law enforcement might set up a security perimeter around an area in response to an accident or a security incident that may include essential security (and threat) information, which should not be exposed to the general public during the course of the investigation or for the duration in which a rescue operation is in progress. In such cases, a trusted third party (possibly the government regulatory) could indicate the level of security. In another example, the specific UE and the perimeter may be dynamically configured by a trusted third party (possibly the government regulatory) in which the perimeter applies only for a specific duration of time. Consequently, the sensing data that is collected should be identified based on the presence of the specific UE (or multiple UE's together) at the duration of time as configured. In another example, the specific UE may be used for setting the perimeter only if it is carried by an individual human or in the presence of a specific pre-identified object. This would be to identify the case where the officers on duty have a specific different perimeter as compared to the case when the same officer is off duty.

The SLMF can ensure that specific sensing information captured from the perimeter is available only to the authorized entities that has the required level of authority. In some examples, based on the list of the allowed nodes for transmission of a sensing signal, a list of allowed nodes for reception of a sensing signal, and/or the filter applied on the information in the reports, the security perimeter is determined based (at least in part on) the type of the measured or derived sensing data, and/or the expected type of sensing results. In one such example, the sensing result type associated with the presence of an object within a defined sensing area of interest follows a different set of considerations (of the allowed Tx/Rx nodes, filters, security/privacy perimeters) compared to the sensing result type.

With reference to a privacy perimeter for sensing, it can be understood that an individual citizen has right to privacy (e.g., general data protection regulation (GDPR)). There should be functions in place for the SLMF to ensure the privacy of a household, pets, and other personal holding be excluded from the sensing data if an individual chooses to do so (by means of sensing not allowed, permitted, or authorized configurations). In this case, the requested sensing restrictions configuration should be maintained by the SLMF and the data observed from the defined area should not be used for the reports generated from the sensing nodes in the specific area as requested by the individual.

Alternatively, the 3GPP network may request the user consent from the desired user for the retrieval of any sensing-related information that is related to or identifiable to a UE and/or a corresponding user—which may include but not limited to household, pets, vehicles or any other observable personal belongings that the sensing function can detect. There could be a separate signaling—a request to the user for consent, and a response to capture user's preferences and a final indication reminding the user of the captured preferences. In another example, it may be required to have a statutory mandate notifying the user of a sensing operation if the sensing operation could have the potential to capture an information on an object (a static object such as a household, or movable object such as a vehicle or pet, or the user himself) belonging to the user. Depending on the type of request, the security and authorization levels configured for the UE and the SLMF client, and the information that need to be captured, the notification could be delivered only if it is required to be transmitted.

For instance, the user may be notified about a sensing operation that is initiated in the vicinity of the user's apartment according to the mandated privacy laws of the country. In some instances, it may be necessary to get the explicit user consent to allow a report to be sent if the location and perimeters of sensing operation overlaps with user's ownership (or restricted) area. The SLMF could (in some cases mandated) also provide a privacy and exception report(s) for all the sensing operations that are connected with the user in case of a subscription of a UE/User's belongings. This could be a statutory regulation, user's choice to subscribe, or a value-added service provided by the network statistics. In some examples, the sensing request could be masked, such that nodes are not aware of what requests are for, and which entity is requesting the report. In the same way the reports do not reference the nodes that participated in the sensing process.

With reference to exclusions for security and privacy configuration, even when the security and privacy configurations are in place, it is understood that some specific sensing data could be used for life saving emergency assistance. Complete stoppage of sensing should only be applied in sufficiently important situations. In one example, when a flood/storm alert issued by the emergency alert mechanism for the area, the sensing privacy setting could be overridden so that the emergency services can execute the response faster and more efficiently. In order to achieve this, the sensing data request and the entity requesting the data should be authenticated. The security level configuration defined as example in the section above could be used to implement such a function where the emergency request should only be allowed from the authorized client, and the request should indicate sufficient authorized security level.

In another example, a military or secure research facility where the sensing signals could have a detrimental impact on the functioning of the premises, and where the national security concerns prevent sensing operation. It is essential to completely block the sensing signals around the perimeter that is defined. The security level configuration in the sensing restrictions could be highest in such cases to prevent any client or request from sending sensing RS to the specific area and abide by the restrictions. In some examples, the indication of a sensing task/operation being of a high priority/significance is indicated by the sensing data consumer to the network, as part of the sensing task/information request. In some other examples, such priority is determined by the SF, upon the reception of the sensing task description. In some examples, the individual nodes—either RAN elements, or the UE—could opt out of the sensing process. The nodes could respond with “Unable to do sensing due to low power”, or “Congested, cannot allocate RS resources” or any text describing the sensing failure. According to one implementation, the agreed upon user consent/permissions/authorization may be overridden, provided that the request is categorized according to a specific privacy class associated to a public safety, emergency, or regulatory agencies/bodies.

With reference to sensing data aggregation and statistical information delivery, when security and privacy restrictions are in place, some of the data could still be used for aggregation and statistical information analysis such as crowd detection, traffic density assessments and other statistical analytics. If a specific LCS client requires the data specific to the area, which includes at least in part a section of secure or privacy perimeter, the statistical data could still be used to generate the report as long it is not individually identifiable such as in the case of data aggregation. In one example, this could also be identified by the security level where one security level indicates allowing of the statistical data, and another blocking the statistical data. An example of this, is the case where LCS client requesting the crowd size measurements around the specific perimeter. Even if a part of the requested perimeter belongs to privacy or security cover, the crowd density measurements could still count (or have an aggregate estimation) of the requested perimeter. A UE could request the crowd statistics information around the device which could be used by the application on the device. (example: Walking alone in the night a warning could be triggered if someone is following the user or a dangerous animal is found in the vicinity) In this case, the crowd activity level, and the size of the crowd may be important but without any specific detail about the actual objects in the area around the device. Some statistical information could also be filtered before the delivery of the report to the client, if so necessary, based on the security level of the request, UE, the RAN Nodes, and the client.

With reference to UDM for security and privacy management for sensing, the core network UDM/UDR is responsible for maintaining the subscriber profile, privacy settings, access rights and other service specific parameters. The same (or similar) registry can be used to receive the privacy and security settings related to the sensing framework such as subscriber/user's sensing authorization/permission/user consent along with its respective validity/time period to allow sensing to be done/to expose the sensing related information. One possible set of the SRC required to safeguard privacy and security requirements may be classified as: The UE-ID which can be verified by the AMF, or a trusted third-party identification register function, or an equivalent distributed identifier document presented by the UE; Associated to each UE-ID, a perimeter defined as a radial distance around the specific UE to be considered for security or privacy settings; Associated with each combination of UE-ID, and the perimeter, a security or privacy authorization level that defines the extend of masking required which could range from “No sensing signals to be transmitted” to “Sensing data to be filter post capture”; A security level that is defined above; An authorization level similar to the definition of security level; Restrictions on parameters, definition of what is allowed to be sensed, such as type of material, identification of objects, or any other identifiable parameter that can be observed by the sensing function; This could also be appended with an optional timestamp and duration which defines the time and duration for which the sensing restrictions apply. In other implementations, a timer or expiration timer may indicate the validity of the sensing restrictions.

In some examples, the above defined restrictions may apply (at least in part) for the sensing operation defined via a radio node belonging to RAN (e.g., a network-controlled repeater (NCR) node, A TRP/gNB, etc.). In some such examples, the dedicated security/authorization level or perimeters for sensing operation defined for a RAN node is defined: For each individual RAN node, For all RAN nodes, For all RAN nodes belonging to a specific group (of the same operator, of the same type, of the same geographical area, same TAC etc.).

Another possible set of sensing restrictions configuration would have a static geographic area defined as either a GPS location and the perimeter around the location or as a set of GPS co-ordinates defining a geographic area. This replaces the items a, and b in the list above while the items c and d would be configured along with the location as described above. When “No sensing signals to be transmitted” is configured, it is translated to the Tx-nodes such that the sensing signals do not reach the perimeter defined in the SRC. This is required in certain extreme high security locations, or the cases where the sensing signals could interfere with the life-saving machinery near to hospitals or ambulances, or nuclear power stations or similar establishments which require tight control of radio signals in the perimeter. Alternatively, the Tx-nodes with the antenna configuration in a certain direction that corresponds to the perimeter may be disabled/muted/deactivated, e.g., Tx beams with certain spatial direction information towards a certain area/perimeter.

When “No signals to be reported” is configured, it is translated to Rx-nodes such that even when the signals are present as configured around the sensing area of the node it should not send the reference signal measurements. This may be a requirement for GDPR regulations when some specific security and privacy mandate is required, the sensing data may not be captured to meet the regulatory requirements. When “Sensing data to filter post capture” is configured, the data restrictions are applied only at the delivery of the sensing and location data.

In another example, additional authorization levels could be tied to the geographic location or time based on the authority or ownership when requested security levels are similar. For example, a user Beta who intrudes into the restricted area that belongs to Alpha who has requested intruder detection subscription for the person's private property of a farm should not be allowed to restrict sensing while Beta is indeed intruding into the restricted area. However, if a law enforcement officer Charlie is entering the restricted perimeter of the user Alpha, this should not be reported as an intrusion as applicable by the law of the region and restriction settings requested by the statutory agencies.

The Authorization level could also be a number to indicate the authorization ladder. A higher value could indicate higher authorization level which overrides the lower authorization levels. The Authorization level could also be tied to the extent of detail that the sensing function is allowed (or disallowed) to capture. One of the authorization levels could be “Only Statistical information” which allows sensing or reporting of statistical information. Increasing levels of authorization could be defined which might also require more intensive and deep scanning process. It should be noted that additional options could be configured to filter or attenuate the RS Tx or Rx nodes in the way that is required to establish the security and privacy framework and the above explanation is just an example for sensing restrictions configuration.

Referring again to FIG. 5, for the purpose of describing the functionality, an example geographical arrangement of sensing nodes, security node and objects for sensing as defined in FIG. 5 can be used. In this example, the UE-U4 has the subscription that allows the UE to the define a security perimeter for the geographical perimeter around the device. It should be understood that in case of the area is a fixed geographical location or any other identifiable geographical perimeter, the functionality explained in the below flow diagrams still applies. It is also noted understood that the UE-U4 is already known to the network, and the authentication is done by the AMF/AuSF network functions in conformance with the existing protocols. The workflow is high level description specific to the sensing function and the finer details of the implementation could include one or more of interactions with other network entities not present in the diagram in compliance to the existing network implementation to achieve the desired result.

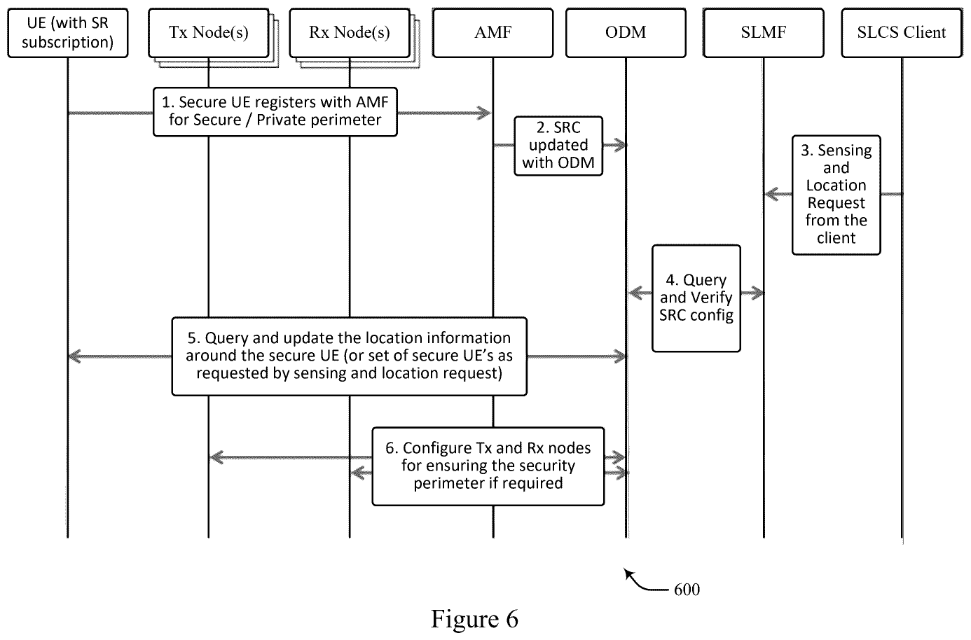

FIG. 6 illustrates an example procedure 600 for an SRC-enabled sensing function to configure SLMF security, in accordance with aspects of the present disclosure. In this example, the UE-U4 has requested (at step 1) a security/privacy perimeter that is identified as the orange circle. The SRC requirements including the UE-ID and perimeter for the UE U4 is requested with the AMF with the intend that the nodes that are geographically stationed inside the perimeter at the time of the sensing function is excluded from the Sensing and Location identification process. Once authenticated by the AMF (at step 2) (which may include further communication with other network functions), the information is updated with the UDM/UDR registry for storage.

A sensing and location request is received (at step 3) from the SLCS client to the SLMF function of the core network. It may be also such that the client may not interface directly with an LMF/SLMF. There may be intermediate entity, such as a gateway mobile location center (GMLC) or network exposure function (NEF), which receives the request from the client then interacts with the AMF authenticating the client and the request itself. This might also include a prior registration process that enlists the requesting entity as “allowed” to send such a request. In another example, the requesting entity may present a DID document to authorize which may require another communication with the DID network function to verify the identity and authorize the request. The functionality described here, indicates the reception of the request at SLMF after completing the necessary security, authorization, verification and validation procedures.

The SLMF initiates (at step 4) verification of the Sensing and Location Request from the client. During this process, SLMF also verifies the authorization level for the incoming request either based on the client identification, security parameters included in the request, or by using a DID document presented by the client for the request. Once the authenticity of the incoming SLCS request is verified, the SLMF requests (at step 5) the update of relevant security/privacy and location settings for all the nodes and locations relevant to the incoming request. This might involve one or more communication with the nodes, and secure UE's to ensure the availability of the nodes, the location information from the nodes, and validity of the SRC settings securely stored in the UDM/UDR registry.

At the end of Step 5, the SLMF has captured the details: The identification of the SLCS client that is requesting the information, the geo-location of the requested SLCS data, the details of requested sensing data from the incoming request; List of relevant nodes, locations, and UE-ID's that have an overlapping perimeter to the request identified in (a); Updated location information, and SRC settings for all the relevant UE's and secure locations that has an overlap and likely to have an overlap (in case of mobility of a secure UE is detected) for the duration of the sensing procedure. With the data, SLMF in coordination with UDM/UDR and AMF analyses (at step 6) the requirements for the incoming request and identifies the Tx and/or Rx nodes which are in the identified perimeter that can be activated for the sensing function. Based on the security settings in the SRC, the sensing configuration parameters are transmitted to the relevant nodes. These parameters would also include specific directions to Tx nodes to specifically transmit RS beams only in the direction that would meet with the security/filter restrictions that the active sensing operation needs to adhere to. Conversely, the Tx nodes are also prohibited from transmitting Tx RS signals where no sensing signals area allowed.

In case the Tx node is a mobile UE, the SLMF function, in coordination with the AMF and UDM/UDR also monitors the device for any overlapping restriction perimeter and (re)configures the sensing RS signals to adhere to the sensing restrictions. Similarly, for mobile rx node, (re)configurations are done to ensure the Rx is turned off when the UE enters a restricted perimeter. In the geography diagram, Tx-Rx nodes TR2, and TR8 are configured for the transmission and reception of the sensing RS while the nodes R1 and R9 are configured only for reception. UE U6, and Node E5 are excluded from the sensing process for being in the secure perimeter of the secure-UE U4. As a consequence of this, the object O3 would not be captured in the sensing data during this process.

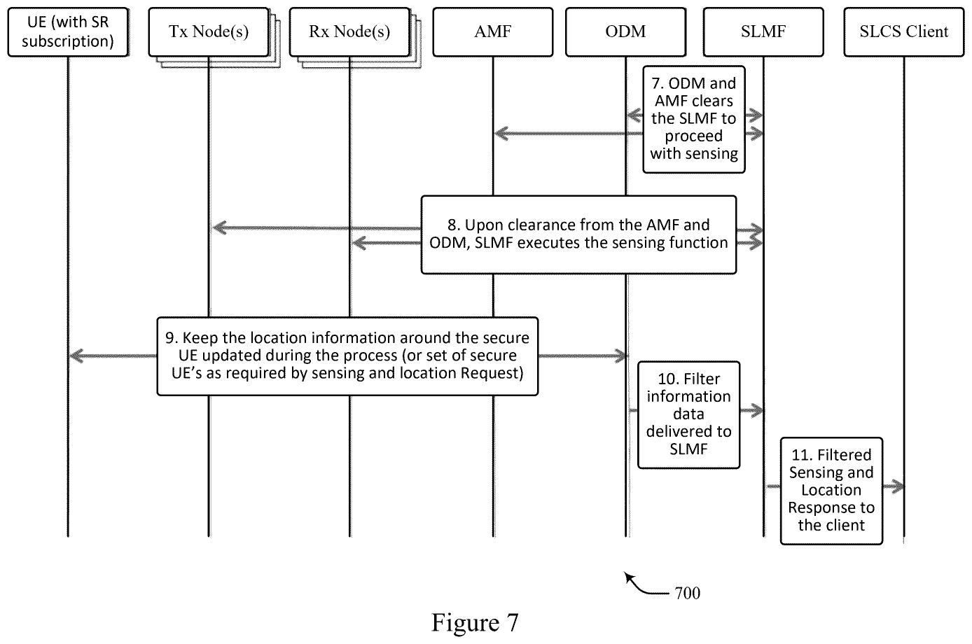

FIG. 7 further illustrates an example procedure 700 for an SRC-enabled sensing function to capture and filter sensing data, in accordance with aspects of the present disclosure. In this example, once the security settings are configured and cleared to proceed is indicated (at step 7) by AMF & UDM/UDR, SLMF can trigger a new sensing function. The SLMF co-ordinates with the configured nodes (at step 8) to capture the requested sensing data. During the process of step 8, UDM/UDR also keeps track (at step 9) of the all the mobility information related to the nodes/UEs which have a relevant SRC setting configured. In case of any change in the SRC data, or location information connected to the active SLMF request, the communications are initiated with AMF and SLMF to honor the security and privacy configurations. This might trigger additional steps similar to (6-8) (actively monitoring all devices). At the end of Step 9, UDM/UDR also delivers (at step 10) the additional filters that need to be applied on the sensing data identified by the SLMF during the process up to step 9. The SLMF delivers (at step 11) the filtered sensing data to the SLCS client.

With reference to a restricted and/or secure sensing function, alternatively, a restricted sensing function can be defined as the one initiated by a UE or a client with additional privileges to include the sensing data from certain limited secure perimeters. An example is the case where the sensing request comes from a UE which has requested specific SRC configuration and is authorized to request sensing. The authorization can also be accomplished by means of an external trusted third party of an DID document presented for the identification of the requesting entity. The workflow defined above remains nearly identical except the configuration of additional nodes to carry out the sensing function. Additional nodes TR5 (for Tx and Rx), U6, and U4 (for Rx) are configured. This would result in the sensing of an additional object O3 which is in the secure perimeter of U4. Similar activation of additional sensing nodes can be done based on the authorization level of the SLCS client and the level of detail requested for the sensing request.

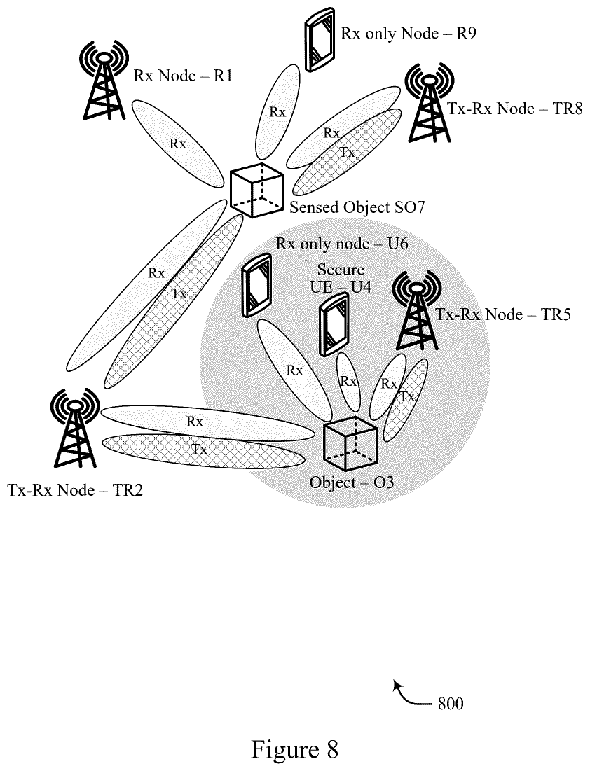

FIG. 8 illustrates an example 800 of a secure sensing function, in accordance with aspects of the present disclosure. In this example, a “secure” sensing function can be defined such that the authorization and security level of the incoming request or client permits a “secure” operation by when only a subset of registered or capable devices or sensing nodes can be included in the sensing operation. For instance, the law enforcement authority could request for a sensing operation that is routed only to specific secure devices or RAN Nodes which is allowed for the specific type of “secure” sensing operation. In an additional example, the operation may be configured to use specific signals for RS, or an additional level of security may be used in exchanging the parameters and configuration of sensing between the sensing nodes, AMF, UDM/UDR and other network functions involved.

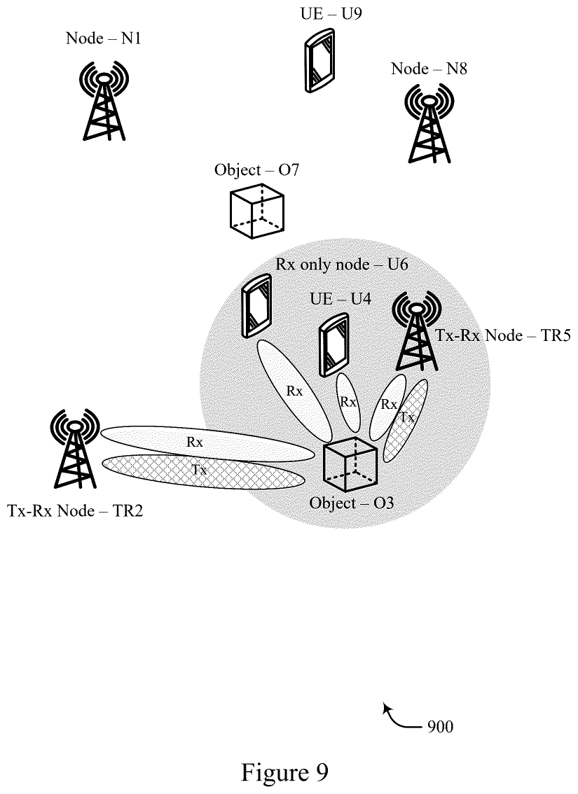

FIG. 9 illustrates an example 900 of a sensing perimeter definition for a registered UE, in accordance with aspects of the present disclosure. With reference to sensing a perimeter definition for registered UEs, a similar approach as defined in the sections above can be alternatively used to limit the sensing data for handling SLCS requests from the UE's registered to the network. In such cases, each UE should be limited to accessing a perimeter that is defined by the authorization level assigned to the UE's subscription.

The example defined in this use case is to enable the protocol functions and applications to request specific sensing parameters around the UE so that UE can optimize protocol resources, or trigger actions in the device in response to receiving sensing information updates from the registered network. While an application or framework running as a service in the mobile device could achieve this by using the common API framework (CAPIF) for accessing the SLMF functions on the 3GPP network, the method using the 3GPP signaling is much more efficient and suitable for optimizing the cellular modem functions (or similar firmware triggers connected to the wireless communication chipsets).

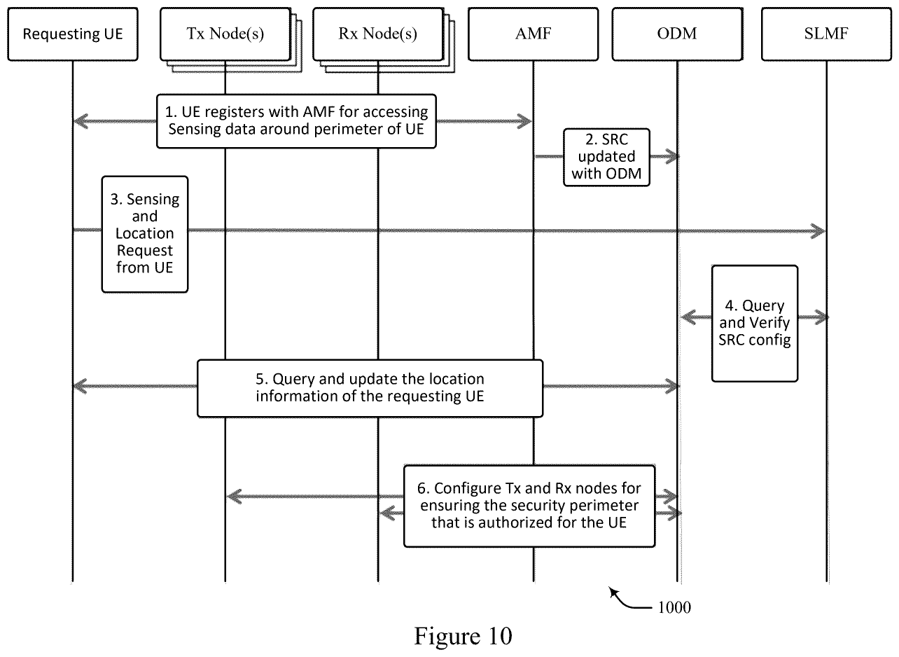

FIG. 10 illustrates an example procedure 1000 for sensing a registration request from a registered UE, in accordance with aspects of the present disclosure. In this example, the UE-U4 also has the additional capacity to register for sensing data and initiating a sensing data request. The sensing data registration request from the UE-U4 is authorized (at step 1) by the AMF based on the subscription parameters. The SRC configuration for the UE4 is updated (at step 2) with UDM/UDR in coordination with the AMF and other subscriber configuration information available within the UDM/UDR (and other core network elements). When a sensing request is received from the requesting UE, SLMF receives (at step 3) the request and considers UE as another SLCS Client. The signaling between the SLMF and UE could be 3GPP NAS signaling using the underlying AS system. Upon receiving the request, the SLMF verifies (at step 4) the authorization levels, and fetches the SRC configuration from the UDM/UDR registry. If required, additional location data is requested (at step 5) from the requesting UE. Once all the data required for sensing is captured, the SLMF configures (at step 6) the relevant nodes to capture the sensing data. In this example, for the UE-U4, the sensing perimeter is defined as the orange circle. The configured sensing nodes are TR2 and TR5 (for Tx and Rx), Rx Only nodes (U4 and U6) in which the U4 is also the requesting UE.

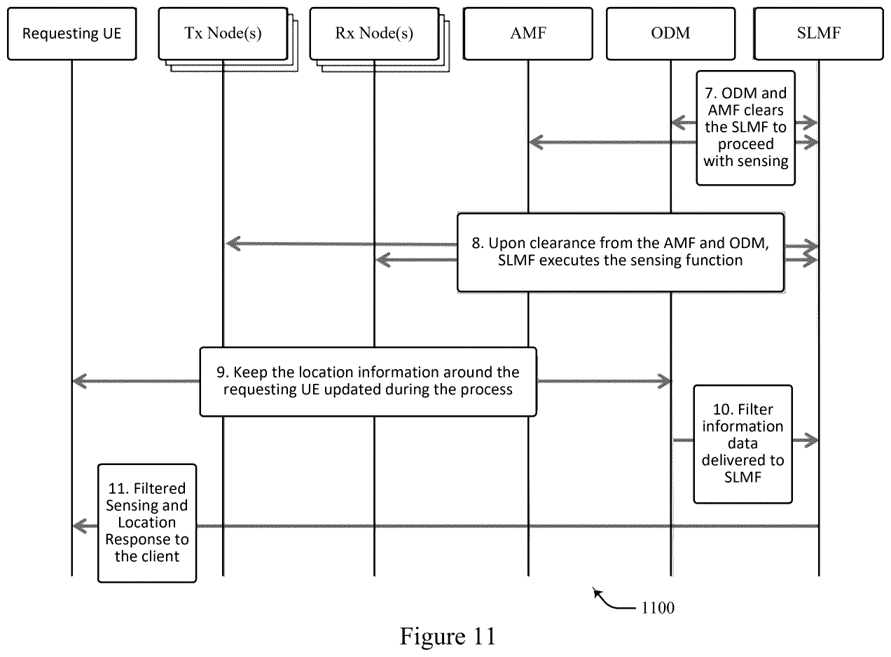

FIG. 11 further illustrates an example procedure 1100 for sensing data delivery to a registered UE, in accordance with aspects of the present disclosure. In this example, once the nodes are configured, UDM/UDR and AMF allows (at step 7) the SLMF to proceed with the sensing function. The SLMF communicates with the nodes (at step 8) and captures the sensing information. During the sensing process, the location of the requesting device is continuously updated (at step 9) so that the perimeter can match the mobility of the device. Final filtering is applied (at step 10) to the sensed data before sending it to the UE. The process ends (at step 11) with the UE receiving the requested data (using a NAS sensing data delivery message).

With reference to sensing and privacy subscription, in one or more implementations, the sensing preferences could be based on (or tied to) a subscription from one (or more) carrier. The subscription configuration can include any one or more of the following described. The perimeter that the UE is requesting the sensing restriction, where the perimeter in this case could defined as an area around the originating UE expressed as radial distance in meters. This could also be a perimeter around a static geo-location, or a set of geo-location co-ordinates which defines a polygonal area for the restrictions. The RS restrictions: type of restrictions indicate the signal restrictions imposed on the perimeter defined above. The values are indicative of whether the restrictions define a complete exclusion from any emitted RS for sensing purposes, or a restriction for the devices in the perimeter to NOT report ANY sensing response, or a filtering for a specific report. An activity & material restrictions: type of restrictions indicate whether the parameters such as the build of material, size, velocity, orientation (or any characteristic identifiable by the sensing function tied to the object) of some of the objects are allowed to be reported or not.

Capturing or tracking of moving objects or identifying and securing a dynamic location around specific UE could be an explicit option in the subscription. The tracking or capturing of an object which is not stationary might require more resources (radio resources as well as computing resources) in the sensing process. There could be a separate subscription option for identifying changes, or intruders in a specific area. This could also include what type of intrusions are subscribed-in some cases it could be detection of humans in the area, in another it could be a human and animal, or in some cases it could include detection of airborne projectiles or UAV's. Security level: Indicates the security level associated with this subscription. Authorization Level: It is necessary to also define the authorization level for the restrictions which defines the ownership of premises, or location where the sensing can be done.

For example, authorization level for a user on the property (or a geographic area) belonging to the user could be higher than the same user's authorization level on a public area such as an airport or a public park. In this case, the user is allowed to subscribe for sensing restrictions on the property or area that can be verified to be belonging to the same user but cannot be authorized to request sensing restrictions on a public park or common public area. Depending on the definition of the public or shared spaces, user or UE or an LCS client could be restricted from sensing some or all of data from the public or shared space. In another example, where an organization request that restricts the sensing operation to anyone except the authorized clients, these restrictions should take precedence over other authorizations in the overlapping region. A combination of security and authorization level could be used by the SLMF to identify what type of sensing is allowed, what sensing data can be captured, which nodes can get involved (or should be excluded) in the specific sensing operation.

In any case, the most restrictive result should be considered as the sensing area to ensure that every criterion defined in the SRC is implemented. Timestamp and duration could define a time window that the restrictions apply. Apart from user subscription configurations, network or statutory entities may define a Sensing Policy function where the users of different authorization/security levels can be further restricted to what can be subscribe for, or whether the user is allowed to/restricted from modifying the security and privacy configurations. The policy definitions could also describe specific areas as public, private, shared or corporate to define the specific ownership parameters. In some cases, the statutory functions may provide the required configuration policy to the network provider. These policies could be based on the location, and a timer or a schedule as required by the statutory recommendations.

With reference to storage, compliance, and statistical analysis of sensing data, some sensing requests, or operations, might require statistical sensing data or a past sensing data that is stored in the SLMF or an accompanying storage framework. In case of data that is stored the sensing restrictions shall still be applied as per the policy, and restrictions configuration at the time of the sensing operation. Additional restrictions may apply at the time of the new request based on the type of the new request, or the origin of the request. It should be emphasized that the essential information around the sensing data, including the policy restrictions, the nodes involved, restrictions applied at the time of the sensing operation and any other data that is relevant to perform a future sensing restrictions should be attached to the actual sensing data captured before storing the data for future use.

The same data can be used for statistical processing of sensing data, where the same restrictions that existed at the time of the sensing operation as per the policy definition if any, should be applied every time the data is used. Further restrictions may have been configured after the acquisition and storage of the sensing data which should also be applied when further sensing requests, statistical processing request or compliance validation requests are responded to, as per the policy definitions. In case of regulatory or statutory compliance verification requests, the necessary information shall be attached to the sensing data as well. In such cases, only the relevant information shall be stored in the SLMF for the compliance requirements.

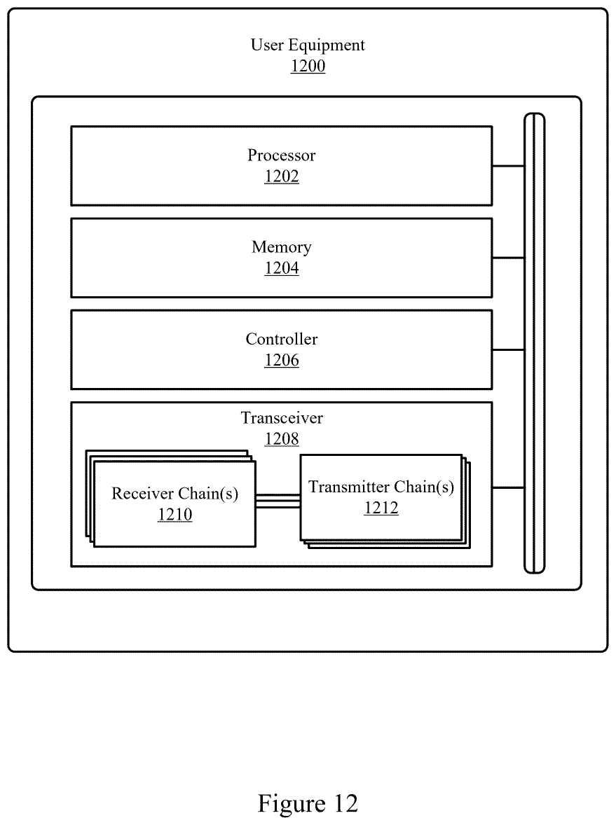

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving one or more reference signals that represent at least one of transmitted or received signal paths evaluated for integrated sensing and positioning detection by joint measurement of signal parameters of one or more of the transmitted or received signal paths; and receiving a sensing configuration that indicates one or more computation exclusions of at least one of the signal parameters of the transmitted or received signal paths from evaluation of the joint measurement for the integrated sensing and positioning detection.

Additionally, the UE 1200 may be configured to or operable to support any one or combination of the method further including at least one of precluding transmission of a RS, restricting a direction of the transmission of the RS, or modifying a power of the transmission of the RS based on the sensing configuration. The method further including precluding at least one of receiving a RS or processing the RS based on the sensing configuration. The method further including precluding sensing data as the at least one signal parameter of a RS based on the sensing configuration. The device is operable as UDM and UDR, and the method further including maintaining the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution. The device is operable as SLMF, and the method further including: at least one of receiving a request for a sensing operation, applying restrictions on the sensing operation, or modifying the restrictions on the sensing operation; authenticating at least one of the request for the sensing operation or the restrictions on the sensing operation; and transmitting, to one or more of a UE or an NE, a (re)configuration message to (re)configure at least one of the one or more computation exclusions or the restrictions on the sensing operation. The method further including monitoring restrictions on a sensing operation in one or more of an identified fixed geographic area or within a perimeter around a fixed geographic location based on the sensing configuration. The method further including at least one of applying restrictions on a sensing operation to a first set of devices, or excluding a second set of devices from the restrictions on the sensing operation.

Additionally, or alternatively, the UE 1200 may support at least one memory (e.g., the memory 1204) and at least one processor (e.g., the processor 1202) coupled with the at least one memory and configured to or operable to cause the UE to receive one or more reference signals that represent at least one of transmitted or received signal paths evaluated for integrated sensing and positioning detection by joint measurement of signal parameters of one or more of the transmitted or received signal paths; and receive a sensing configuration that indicates one or more computation exclusions of at least one of the signal parameters of the transmitted or received signal paths from evaluation of the joint measurement for the integrated sensing and positioning detection.

Additionally, the UE 1200 may be configured to or operable to support any one or combination of the at least one processor is operable to cause the device to at least one of preclude transmission of a RS, restrict a direction of the transmission of the RS, or modify a power of the transmission of the RS based on the sensing configuration. The device is a receiving device, and the at least one processor is operable to cause the receiving device to preclude at least one of receiving a RS or processing the RS based on the sensing configuration. The at least one processor is operable to cause the device to preclude sensing data as the at least one signal parameter of a RS based on the sensing configuration. The device is operable as UDM and UDR, and the at least one processor is operable to cause the UDM and UDR to maintain the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution. The device is operable as SLMF, and the at least one processor is operable to cause the SLMF to at least one of receive a request for a sensing operation, apply restrictions on the sensing operation, or modify the restrictions on the sensing operation; authenticate at least one of the request for the sensing operation or the restrictions on the sensing operation; and transmit, to one or more of a UE or an NE, a (re)configuration message to (re)configure at least one of the one or more computation exclusions or the restrictions on the sensing operation. The at least one processor is operable to cause the device to monitor restrictions on a sensing operation in one or more of an identified fixed geographic area or within a perimeter around a fixed geographic location based on the sensing configuration. The at least one processor is operable to cause the device to at least one of apply restrictions on a sensing operation to a first set of devices, or exclude a second set of devices from the restrictions on the sensing operation. The at least one processor is operable to cause the device to override restrictions on a sensing operation based on emergency, statutory, or geographic authority exclusions to at least one of add, modify, or remove one or more of the restrictions based on authentication to override the restrictions on the sensing operation.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

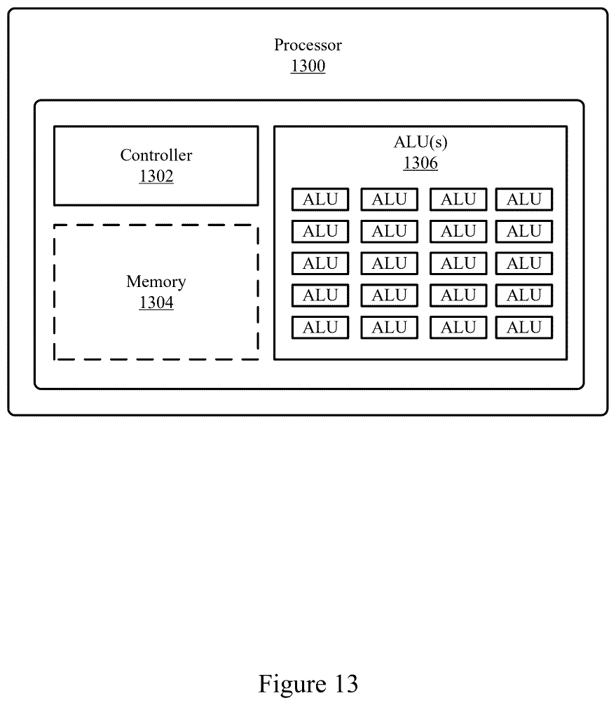

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to support at least one controller (e.g., the controller 1302) coupled with at least one memory (e.g., the memory 1304) and configured to or operable to cause the processor to receive one or more reference signals that represent at least one of transmitted or received signal paths evaluated for integrated sensing and positioning detection by joint measurement of signal parameters of one or more of the transmitted or received signal paths; and receive a sensing configuration that indicates one or more computation exclusions of at least one of the signal parameters of the transmitted or received signal paths from evaluation of the joint measurement for the integrated sensing and positioning detection.

Additionally, the processor 1300 may be configured to or operable to support any one or combination of the device is a UE or an NE. The at least one controller is operable to cause the processor to at least one of preclude transmission of a RS, restrict a direction of the transmission of the RS, or modify a power of the transmission of the RS based on the sensing configuration. The at least one controller is operable to cause the processor to preclude at least one of receiving a RS or processing the RS based on the sensing configuration. The at least one controller is operable to cause the processor to preclude sensing data as the at least one signal parameter of a RS based on the sensing configuration. The at least one controller is operable to cause the processor to maintain the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution. The at least one controller is operable to cause the processor to: at least one of receive a request for a sensing operation, apply restrictions on the sensing operation, or modify the restrictions on the sensing operation; authenticate the at least one of receive the request for the sensing operation, apply the restrictions on the sensing operation, or modify the restrictions on the sensing operation; and transmit, to one or more of a UE or an NE, a (re)configuration message to (re)configure at least one of the one or more computation exclusions or the restrictions on the sensing operation. The at least one controller is operable to cause the processor to monitor restrictions on a sensing operation in one or more of an identified fixed geographic area or within a perimeter around a fixed geographic location based on the sensing configuration. The at least one controller is operable to cause the processor to at least one of apply restrictions on a sensing operation to a first set of devices, or exclude a second set of devices from the restrictions on the sensing operation. The at least one controller is operable to cause the processor to override restrictions on a sensing operation based on emergency, statutory, or geographic authority exclusions to at least one of add, modify, or remove one or more of the restrictions based on authentication to override the restrictions on the sensing operation.

The processor 1300 may support wireless communication in accordance with examples as disclosed herein. The processor 1300 may be configured to support at least one controller (e.g., the controller 1302) coupled with at least one memory (e.g., the memory 1304) and configured to or operable to cause the processor to receive one or more reference signals that represent at least one of transmitted or received signal paths evaluated for integrated sensing and positioning detection by joint measurement of signal parameters of one or more of the transmitted or received signal paths; and receive a sensing configuration that indicates one or more computation exclusions of at least one of the signal parameters of the transmitted or received signal paths from evaluation of the joint measurement for the integrated sensing and positioning detection.

Additionally, the processor 1300 may be configured to or operable to support any one or combination of the device is a UE or an NE. The at least one controller is operable to cause the processor to at least one of preclude transmission of a RS, restrict a direction of the transmission of the RS, or modify a power of the transmission of the RS based on the sensing configuration. The at least one controller is operable to cause the processor to preclude at least one of receiving a RS or processing the RS based on the sensing configuration. The at least one controller is operable to cause the processor to preclude sensing data as the at least one signal parameter of a RS based on the sensing configuration. The at least one controller is operable to cause the processor to maintain the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution. The at least one controller is operable to cause the processor to: at least one of receive a request for a sensing operation, apply restrictions on the sensing operation, or modify the restrictions on the sensing operation; authenticate the at least one of receive the request for the sensing operation, apply the restrictions on the sensing operation, or modify the restrictions on the sensing operation; and transmit, to one or more of a UE or an NE, a (re)configuration message to (re)configure at least one of the one or more computation exclusions or the restrictions on the sensing operation. The at least one controller is operable to cause the processor to monitor restrictions on a sensing operation in one or more of an identified fixed geographic area or within a perimeter around a fixed geographic location based on the sensing configuration. The at least one controller is operable to cause the processor to at least one of apply restrictions on a sensing operation to a first set of devices, or exclude a second set of devices from the restrictions on the sensing operation. The at least one controller is operable to cause the processor to override restrictions on a sensing operation based on emergency, statutory, or geographic authority exclusions to at least one of add, modify, or remove one or more of the restrictions based on authentication to override the restrictions on the sensing operation.

The processor 1300 may support wireless communication in accordance with examples as disclosed herein. The processor 1300 may be configured to support at least one controller (e.g., the controller 1302) coupled with at least one memory (e.g., the memory 1304) and configured to or operable to cause the processor to receive a request for a sensing operation for integrated sensing and positioning detection by joint measurement of signal parameters of one or more transmitted or received signal paths; authenticate the request for the sensing operation; apply one or more computation exclusions of at least one of the signal parameters of the transmitted or received signal paths from evaluation of the joint measurement for the integrated sensing and positioning detection; and transmit, to one or more of a UE or additional NE, a sensing configuration message for the integrated sensing and positioning detection.

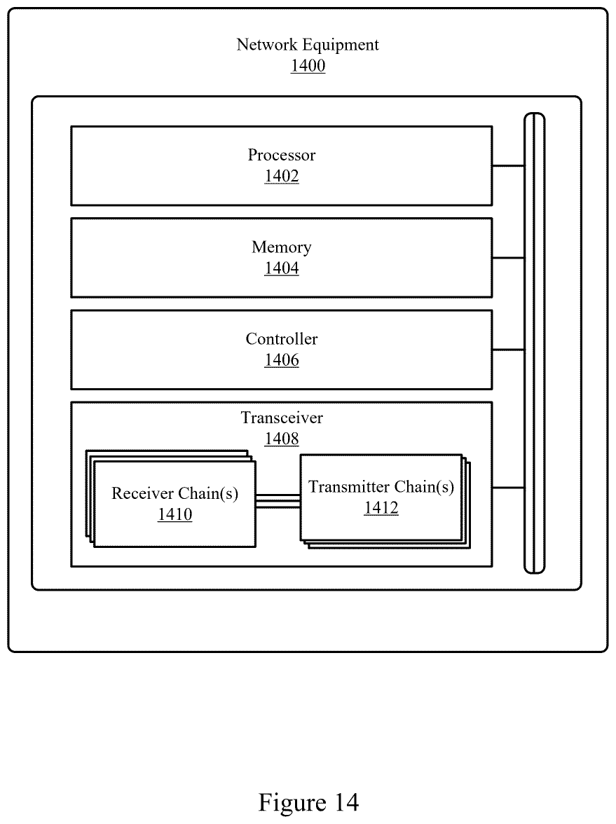

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for receiving one or more reference signals that represent at least one of transmitted or received signal paths evaluated for integrated sensing and positioning detection by joint measurement of signal parameters of one or more of the transmitted or received signal paths; and receiving a sensing configuration that indicates one or more computation exclusions of at least one of the signal parameters of the transmitted or received signal paths from evaluation of the joint measurement for the integrated sensing and positioning detection.

Additionally, the NE 1400 may be configured to or operable to support any one or combination of the method further including at least one of precluding transmission of a RS, restricting a direction of the transmission of the RS, or modifying a power of the transmission of the RS based on the sensing configuration. The method further including precluding at least one of receiving a RS or processing the RS based on the sensing configuration. The method further including precluding sensing data as the at least one signal parameter of a RS based on the sensing configuration. The device is operable as UDM and UDR, and the method further including maintaining the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution. The device is operable as SLMF, and the method further including: at least one of receiving a request for a sensing operation, applying restrictions on the sensing operation, or modifying the restrictions on the sensing operation; authenticating at least one of the request for the sensing operation or the restrictions on the sensing operation; and transmitting, to one or more of a UE or an NE, a (re)configuration message to (re)configure at least one of the one or more computation exclusions or the restrictions on the sensing operation. The method further including monitoring restrictions on a sensing operation in one or more of an identified fixed geographic area or within a perimeter around a fixed geographic location based on the sensing configuration. The method further including at least one of applying restrictions on a sensing operation to a first set of devices, or excluding a second set of devices from the restrictions on the sensing operation.

Additionally, or alternatively, the NE 1400 may support at least one memory (e.g., the memory 1404) and at least one processor (e.g., the processor 1402) coupled with the at least one memory and configured to or operable to cause the NE to receive one or more reference signals that represent at least one of transmitted or received signal paths evaluated for integrated sensing and positioning detection by joint measurement of signal parameters of one or more of the transmitted or received signal paths; and receive a sensing configuration that indicates one or more computation exclusions of at least one of the signal parameters of the transmitted or received signal paths from evaluation of the joint measurement for the integrated sensing and positioning detection.

Additionally, the NE 1400 may be configured to or operable to support any one or combination of the at least one processor is operable to cause the device to at least one of preclude transmission of a RS, restrict a direction of the transmission of the RS, or modify a power of the transmission of the RS based on the sensing configuration. The device is a receiving device, and the at least one processor is operable to cause the receiving device to preclude at least one of receiving a RS or processing the RS based on the sensing configuration. The at least one processor is operable to cause the device to preclude sensing data as the at least one signal parameter of a RS based on the sensing configuration. The device is operable as UDM and UDR, and the at least one processor is operable to cause the UDM and UDR to maintain the sensing configuration associated with one or more of a UE or an NE, and where the sensing configuration indicates one or more of: one or more restriction parameters relative to at least one of a security level or an authorization level of the UE or the NE; one or more of an identified fixed geographic area, a perimeter around the device or a fixed geographic location of the device; one or more of sensing restrictions, device operation restrictions, or policy restrictions; or conflict resolution for overlapping restrictions of a same geographic location or perimeter, where a highest level of restrictions of the overlapping restrictions is applied for the conflict resolution. The device is operable as SLMF, and the at least one processor is operable to cause the SLMF to at least one of receive a request for a sensing operation, apply restrictions on the sensing operation, or modify the restrictions on the sensing operation; authenticate at least one of the request for the sensing operation or the restrictions on the sensing operation; and transmit, to one or more of a UE or an NE, a (re)configuration message to (re)configure at least one of the one or more computation exclusions or the restrictions on the sensing operation. The at least one processor is operable to cause the device to monitor restrictions on a sensing operation in one or more of an identified fixed geographic area or within a perimeter around a fixed geographic location based on the sensing configuration. The at least one processor is operable to cause the device to at least one of apply restrictions on a sensing operation to a first set of devices, or exclude a second set of devices from the restrictions on the sensing operation. The at least one processor is operable to cause the device to override restrictions on a sensing operation based on emergency, statutory, or geographic authority exclusions to at least one of add, modify, or remove one or more of the restrictions based on authentication to override the restrictions on the sensing operation.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to or operable to support a means for receiving a request for a sensing operation for integrated sensing and positioning detection by joint measurement of signal parameters of one or more transmitted or received signal paths; authenticating the request for the sensing operation; applying one or more computation exclusions of at least one of the signal parameters of the transmitted or received signal paths from evaluation of the joint measurement for the integrated sensing and positioning detection; and transmitting, to one or more of a UE or additional NE, a sensing configuration message for the integrated sensing and positioning detection.

Additionally, or alternatively, the NE 1400 may support at least one memory (e.g., the memory 1404) and at least one processor (e.g., the processor 1402) coupled with the at least one memory and configured to or operable to cause the NE to receive a request for a sensing operation for integrated sensing and positioning detection by joint measurement of signal parameters of one or more transmitted or received signal paths; authenticate the request for the sensing operation; apply one or more computation exclusions of at least one of the signal parameters of the transmitted or received signal paths from evaluation of the joint measurement for the integrated sensing and positioning detection; and transmit, to one or more of a UE or additional NE, a sensing configuration message for the integrated sensing and positioning detection.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

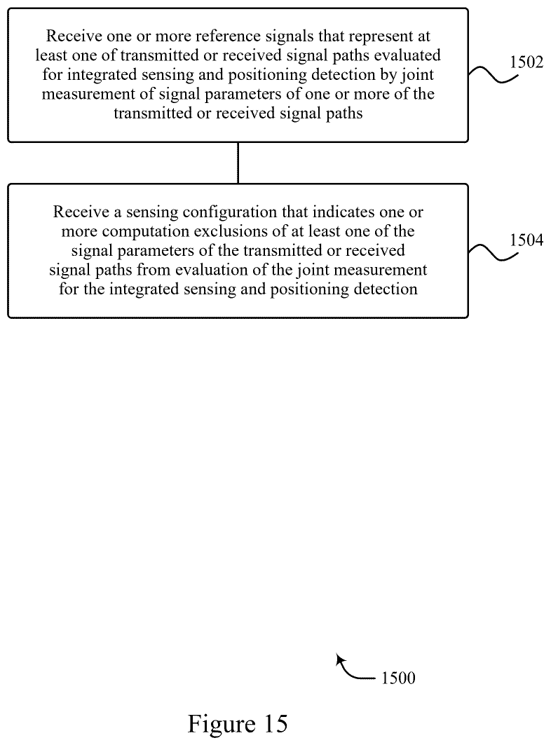

FIG. 15 illustrates a flowchart of a method 1500 in accordance with aspects of the present disclosure. The operations of the method may be implemented by a UE or NE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving one or more reference signals that represent at least one of transmitted or received signal paths evaluated for integrated sensing and positioning detection by joint measurement of signal parameters of one or more of the transmitted or received signal paths. The operations of 1502 may be performed in accordance with examples as described herein. In some implementations, aspects of the operations of 1502 may be performed by a UE as described with reference to FIG. 12 or FIG. 14.

At 1504, the method may include receiving a sensing configuration that indicates one or more computation exclusions of at least one of the signal parameters of the transmitted or received signal paths from evaluation of the joint measurement for the integrated sensing and positioning detection. The operations of 1504 may be performed in accordance with examples as described herein. In some implementations, aspects of the operations of 1504 may be performed by a UE as described with reference to FIG. 12 or FIG. 14.

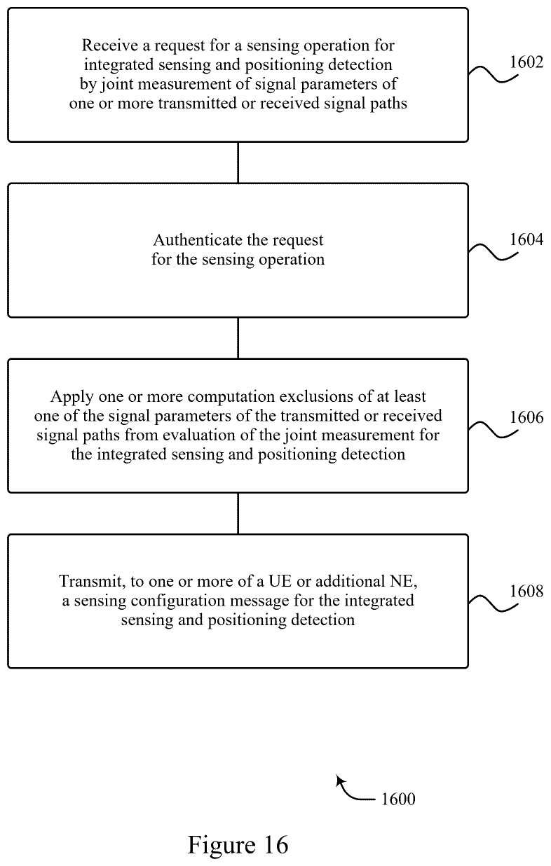

FIG. 16 illustrates a flowchart of a method 1600 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1602, the method may include receiving a request for a sensing operation for integrated sensing and positioning detection by joint measurement of signal parameters of one or more transmitted or received signal paths. The operations of 1602 may be performed in accordance with examples as described herein. In some implementations, aspects of the operations of 1602 may be performed by an NE as described with reference to FIG. 14.

At 1604, the method may include authenticating the request for the sensing operation. The operations of 1604 may be performed in accordance with examples as described herein. In some implementations, aspects of the operations of 1604 may be performed by an NE as described with reference to FIG. 14.

At 1606, the method may include applying one or more computation exclusions of at least one of the signal parameters of the transmitted or received signal paths from evaluation of the joint measurement for the integrated sensing and positioning detection. The operations of 1606 may be performed in accordance with examples as described herein. In some implementations, aspects of the operations of 1606 may be performed an NE as described with reference to FIG. 14.

At 1608, the method may include transmitting, to one or more of a UE or additional NE, a sensing configuration message for the integrated sensing and positioning detection. The operations of 1608 may be performed in accordance with examples as described herein. In some implementations, aspects of the operations of 1608 may be performed an NE as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device for wireless communication, comprising:
at least one memory; and
at least one processor coupled with the at least one memory and operable to cause the device to:
receive one or more reference signals that represent at least one of transmitted or received signal paths evaluated for integrated sensing and positioning detection by joint measurement of signal parameters of one or more of the transmitted or received signal paths; and
receive a sensing configuration that indicates one or more computation exclusions of at least one of the signal parameters of the transmitted or received signal paths from evaluation of the joint measurement for the integrated sensing and positioning detection.

2. The device of claim 1, wherein the device is a user equipment (UE) or a network equipment (NE).

3. The device of claim 1, wherein the at least one processor is operable to cause the device to at least one of preclude transmission of a reference signal (RS), restrict a direction of the transmission of the RS, or modify a power of the transmission of the RS based at least in part on the sensing configuration.

4. The device of claim 1, wherein the device is a receiving device, and the at least one processor is operable to cause the receiving device to preclude at least one of receiving a reference signal (RS) or processing the RS based at least in part on the sensing configuration.

5. The device of claim 1, wherein the at least one processor is operable to cause the device to preclude sensing data as the at least one signal parameter of a reference signal (RS) based at least in part on the sensing configuration.

6. The device of claim 1, wherein the device is operable as unified data management (UDM) and unified data repository (UDR), and the at least one processor is operable to cause the UDM and UDR to maintain the sensing configuration associated with one or more of a user equipment (UE) or a network equipment (NE), and wherein the sensing configuration indicates one or more of:
one or more restriction parameters relative to at least one of a security level or an authorization level of the UE or the NE;
one or more of an identified fixed geographic area, a perimeter around the device or a fixed geographic location of the device;
one or more of sensing restrictions, device operation restrictions, or policy restrictions; or
conflict resolution for overlapping restrictions of a same geographic location or perimeter, wherein a highest level of restrictions of the overlapping restrictions is applied for the conflict resolution.

7. The device of claim 1, wherein the device is operable as sensing and location management function (SLMF), and the at least one processor is operable to cause the SLMF to:
at least one of receive a request for a sensing operation, apply restrictions on the sensing operation, or modify the restrictions on the sensing operation;
authenticate at least one of the request for the sensing operation or the restrictions on the sensing operation; and
transmit, to one or more of a user equipment (UE) or a network equipment (NE), a (re)configuration message to (re)configure at least one of the one or more computation exclusions or the restrictions on the sensing operation.

8. The device of claim 1, wherein the at least one processor is operable to cause the device to monitor restrictions on a sensing operation in one or more of an identified fixed geographic area or within a perimeter around a fixed geographic location based at least in part on the sensing configuration.

9. The device of claim 1, wherein the at least one processor is operable to cause the device to at least one of apply restrictions on a sensing operation to a first set of devices, or exclude a second set of devices from the restrictions on the sensing operation.

10. The device of claim 1, wherein the at least one processor is operable to cause the device to override restrictions on a sensing operation based at least in part on emergency, statutory, or geographic authority exclusions to at least one of add, modify, or remove one or more of the restrictions based at least in part on authentication to override the restrictions on the sensing operation.

11. A method performed by a device for wireless communication, the method comprising:
receiving one or more reference signals that represent at least one of transmitted or received signal paths evaluated for integrated sensing and positioning detection by joint measurement of signal parameters of one or more of the transmitted or received signal paths; and
receiving a sensing configuration that indicates one or more computation exclusions of at least one of the signal parameters of the transmitted or received signal paths from evaluation of the joint measurement for the integrated sensing and positioning detection.

12. The method of claim 11, further comprising at least one of precluding transmission of a reference signal (RS), restricting a direction of the transmission of the RS, or modifying a power of the transmission of the RS based at least in part on the sensing configuration.

13. The method of claim 11, further comprising precluding at least one of receiving a reference signal (RS) or processing the RS based at least in part on the sensing configuration.

14. The method of claim 11, further comprising precluding sensing data as the at least one signal parameter of a reference signal (RS) based at least in part on the sensing configuration.

15. The method of claim 11, wherein the device is operable as unified data management (UDM) and unified data repository (UDR), and the method further comprising maintaining the sensing configuration associated with one or more of a user equipment (UE) or a network equipment (NE), and wherein the sensing configuration indicates one or more of:
one or more restriction parameters relative to at least one of a security level or an authorization level of the UE or the NE;
one or more of an identified fixed geographic area, a perimeter around the device or a fixed geographic location of the device;
one or more of sensing restrictions, device operation restrictions, or policy restrictions; or
conflict resolution for overlapping restrictions of a same geographic location or perimeter, wherein a highest level of restrictions of the overlapping restrictions is applied for the conflict resolution.

16. The method of claim 11, wherein the device is operable as sensing and location management function (SLMF), and the method further comprising:
at least one of receiving a request for a sensing operation, applying restrictions on the sensing operation, or modifying the restrictions on the sensing operation;
authenticating at least one of the request for the sensing operation or the restrictions on the sensing operation; and
transmitting, to one or more of a user equipment (UE) or a network equipment (NE), a (re)configuration message to (re)configure at least one of the one or more computation exclusions or the restrictions on the sensing operation.

17. The method of claim 11, further comprising monitoring restrictions on a sensing operation in one or more of an identified fixed geographic area or within a perimeter around a fixed geographic location based at least in part on the sensing configuration.

18. The method of claim 11, further comprising at least one of applying restrictions on a sensing operation to a first set of devices, or excluding a second set of devices from the restrictions on the sensing operation.

19. A network equipment (NE) for wireless communication, comprising:
at least one memory; and
at least one processor coupled with the at least one memory and operable to cause the NE to:
receive a request for a sensing operation for integrated sensing and positioning detection by joint measurement of signal parameters of one or more transmitted or received signal paths;
authenticate the request for the sensing operation;
apply one or more computation exclusions of at least one of the signal parameters of the transmitted or received signal paths from evaluation of the joint measurement for the integrated sensing and positioning detection; and
transmit, to one or more of a user equipment (UE) or additional NE, a sensing configuration message for the integrated sensing and positioning detection.

20. A method performed by a network equipment (NE), the method comprising:
receiving a request for a sensing operation for integrated sensing and positioning detection by joint measurement of signal parameters of one or more transmitted or received signal paths;
authenticating the request for the sensing operation;
applying one or more computation exclusions of at least one of the signal parameters of the transmitted or received signal paths from evaluation of the joint measurement for the integrated sensing and positioning detection; and
transmitting, to one or more of a user equipment (UE) or additional NE, a sensing configuration message for the integrated sensing and positioning detection.
